(19) United States
(12) Patent Application Publication
(10) Pub. No.: US 2006/0097653 A1
(43) Pub. Date: May 11, 2006

(54) Electric connection assembly of flat panel gas discharge lamp

(75) Inventors: Chin-Wen Chou, Taipei Hsien (TW); Chin-Shan Tsai, Taipei Hsien (TW); Ying-Nan Cheng, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 10/982,816

(22) Filed: Nov. 8, 2004

(51) Int. Cl. H05B 39/04

(52) U.S. Cl. 315/209 R

(57) ABSTRACT

The present invention discloses an electric connection assembly of a flat panel gas discharge lamp, comprising two electric conductors covered on any two corresponding end surfaces of a gas discharge lamp for allowing a power supply to supply electric power to the gas discharge lamp through the conductors and light up the gas discharge lamp. With the structure of simple components, the present invention can achieve the electric connection effect, not only simplifying the manufacturing procedure, but also having the advantages of saving time and cost.

### FIELD OF THE INVENTION

The present invention relates to an electric connection assembly, more particularly to an electric connection assembly of a flat panel gas discharge lamp.

### BACKGROUND OF THE INVENTION

As portable electronic products and communication related industries are booming in recent years, liquid crystal display devices show a substantial growth. In addition to the requirements for a light, thin and compact design, products of this sort also take the easiness for manufacturers to improve or simplify their structure into consideration, not only facilitating the manufacture of these products, but also saving costs.

In general, a backlight unit (BLU) refers to a component for providing a backlight source to a product, and its typical application is to provide a light source to this type of flat panel liquid display devices. For the present light emitting components, there are three main types: an electron luminescence (EL), a cold cathode fluorescent lamp (CCFL) and a light emitting diode (LED); and the light emitting components are divided into two types: a side-back type or a vertically-down type. The common backlight source generally used for the flat panel gas discharge lamps in the market is described together with drawings as follows and its structure is illustrated by FIG. 1. The principle of its operation mainly uses the discharge of a reactant gas (generally an inert gas) to activate the fluorescent material on the light emitting side to emit light and a backlight inverter to supply the required electric power. Refer to R.O.C. Patent Publication No. 521300 entitled “Discharge lamp having support member between bottom chassis and panel used for dielectric resisting discharge” for similar technologies. The flat panel gas discharge lamps of this type is divided into an external electrode type as shown in FIG. 2 and an internal electrode type as shown in FIG. 3 according to the design of the electrodes; wherein a close cavity 12 is defined between an upper glass 10 disposed at a light emitting side and a lower glass 11 disposed at a backlight side; a reactant gas is filled in the cavity 12, and the cross-section of the upper glass 10 usually forms a support section 101 with a support capability and a fluorescent material 13 is coated on the internal side of the cavity 12 proximate to the surface of the light emitting side; a reflective material 14 is coated on the internal wall of the lower glass 11 proximate to the surface of the backlight side for reflecting the downwardly traveling light (i.e. traveling towards the backlight side). The external surface of the external electrode type lower glass 11 is attached to an electrode 15a, 15b, and an insulating layer 16 covers the electrode 15a, 15b. On the other hand, the internal electrode type installs the electrode 15a, 15b disposed inside the cavity 12 as shown in FIG. 3 and uses a support member 17 for supporting the upper glass 10 and the lower glass 11. The electrodes 15a, 15b receive an electric current converted by the backlight inverter 20 as shown in FIG. 1, to drive the reactant gas inside the cavity 12 to generate an electric discharge and discharge an ultraviolet light to activate the fluorescent material 13 to emit light.

The foregoing flat panel gas discharge lamp, regardless the external electrode type as shown in FIG. 2 or the internal electrode type as shown in FIG. 3 is made by either one of the following two methods: pulling a conductive wire (not shown in the figure) into the interior of the flat panel gas discharge lamp or using a layout of the printed circuit board (PCB) to lay the electrodes 15a, 15b (the electrode 15a for the external electrode type is attached on the external surface of the lower glass 1, and the electrodes 15a, 16b for the internal electrode type are installed inside the close cavity 12); and finally performing the packaging procedure. However, the prior-art procedure for laying the electrodes 15a, 15b not only involves a complicated manufacturing procedure, but also requires a complicated design to determine the layout when the size of the flat panel gas discharge lamp is too large. If the electrodes 15a, 15b with their layouts produces a short circuit and the short-circuit situation is not discovered in time, more follow-up processes will be needed. Such arrangement further wastes production costs (for both time and labor), and thus the shortcomings of the prior art is a topic that demands immediate attention and improvement.

### SUMMARY OF THE INVENTION

Therefore, the primary objective of the present invention is to overcome the foregoing shortcomings and avoid the exiting deficiency by providing an electric connection assembly of a flat panel gas discharge lamp that relates to a simple manufacturing procedure and has the time-saving and low-cost features.

To achieve the foregoing objective, the present invention comprises the aforementioned two conductors to cover any two corresponding end surfaces of the aforementioned gas discharge lamp to provide an electric transmission function for a power supply and a gas discharge lamp.

The above and other objects, features and advantages of the present invention will become apparent from the following detailed description taken with the accompanying drawings.

### BRIEF DESCRIPTION OF THE DRAWINGS

FIG. 1 is a perspective view of a prior-art flat panel gas discharge lamp.

FIG. 2 is a cross-sectional view of a prior-art flat panel gas discharge lamp with external electrodes.

FIG. 3 is a cross-sectional view of a prior-art flat panel gas discharge lamp with internal electrodes.

FIG. 4 is a perspective view of the present invention being connected to a power supply.

FIG. 5 is an exploded view of the present invention being connected to a power supply.

FIG. 6 is a cross-sectional view of the present invention being connected to a power supply.

FIG. 7 is a cross-sectional view of another preferred embodiment of the present invention.

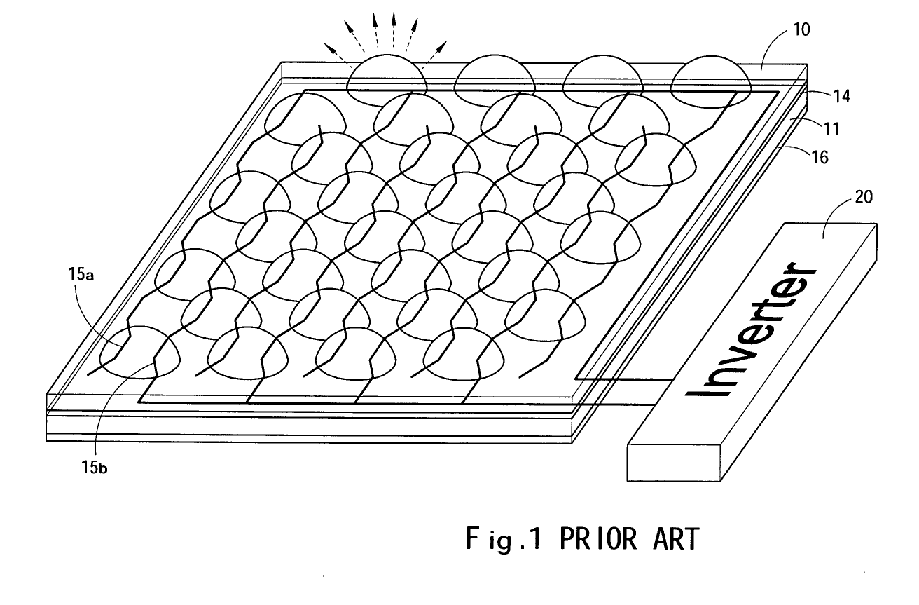

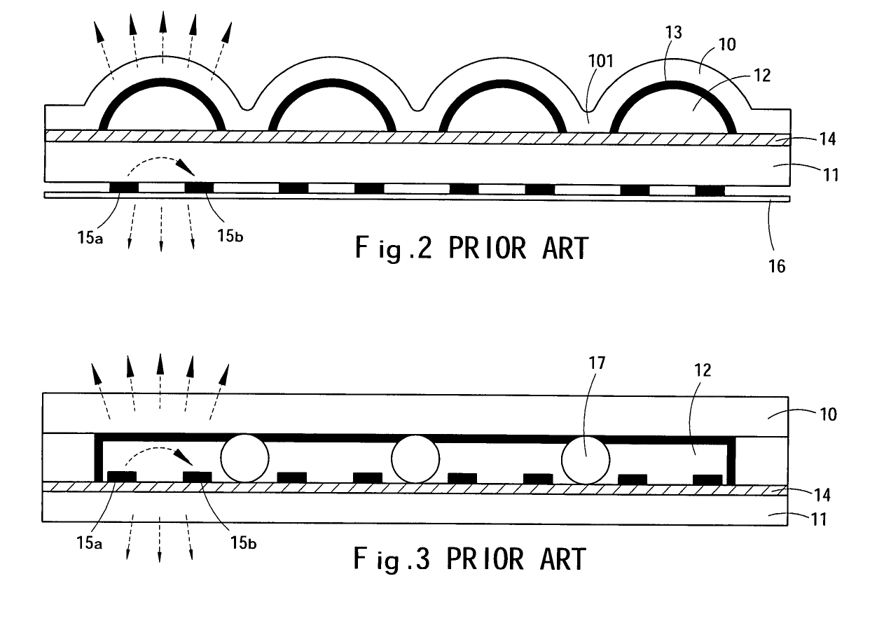

### DETAILED DESCRIPTION OF THE PREFERRED EMBODIMENTS

The present invention installs simple components to achieve the electric connection effect, not only improving the complicated procedure according to the prior arts that requires conductive wires or a printed circuit board (PCB) for the layout of the electrodes, but also having the time-saving and cost-saving advantages. The electric connection assembly of a flat panel gas discharge lamp in accordance with the present invention is described in details together with the attached drawings and labeled numbers as follows:

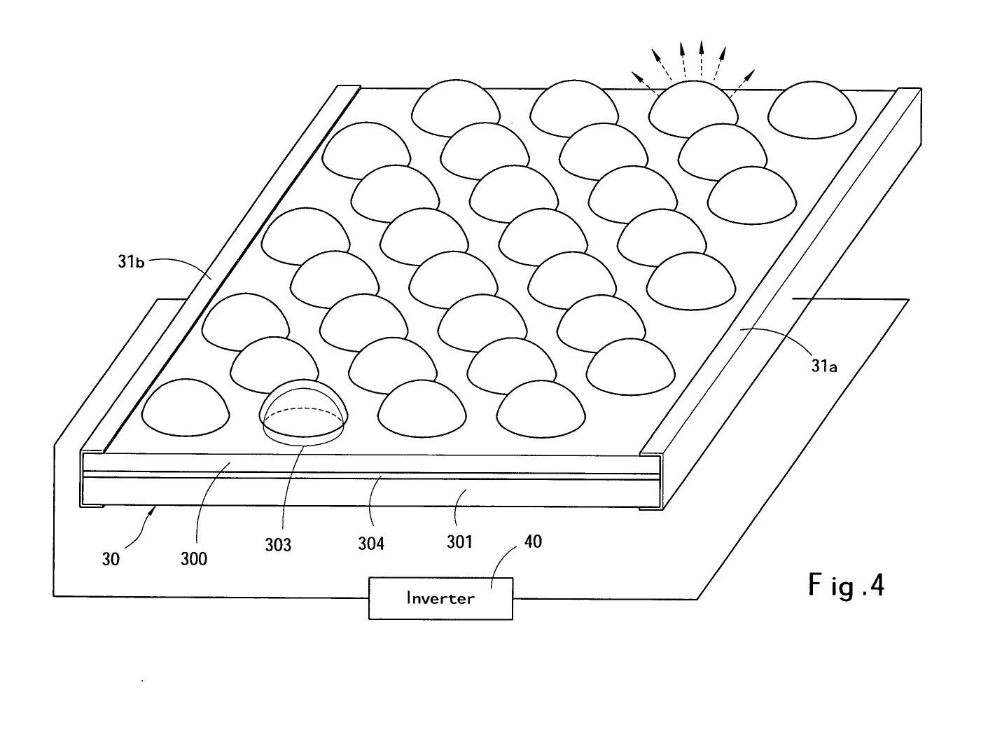

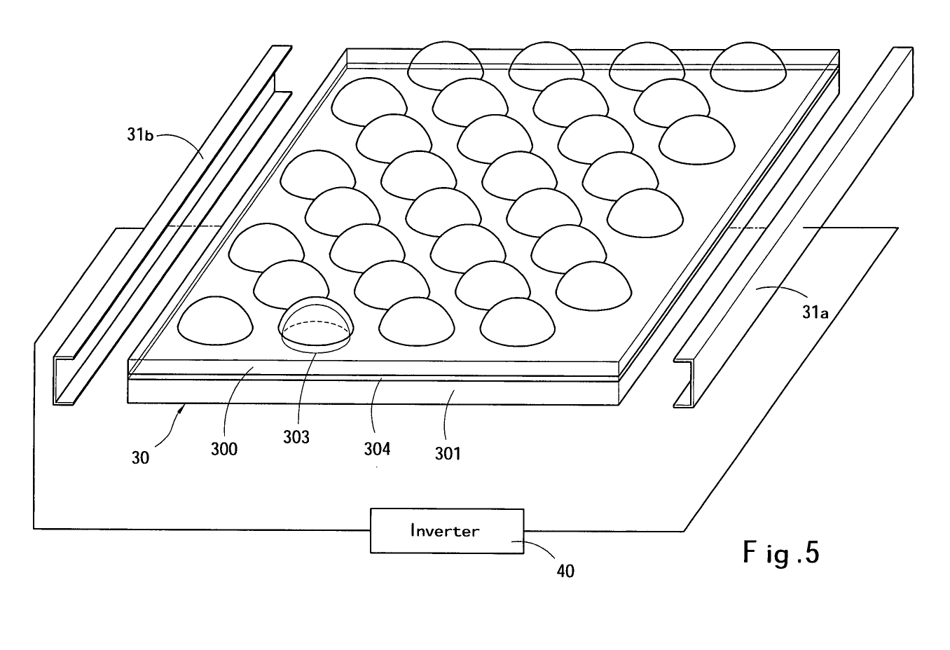

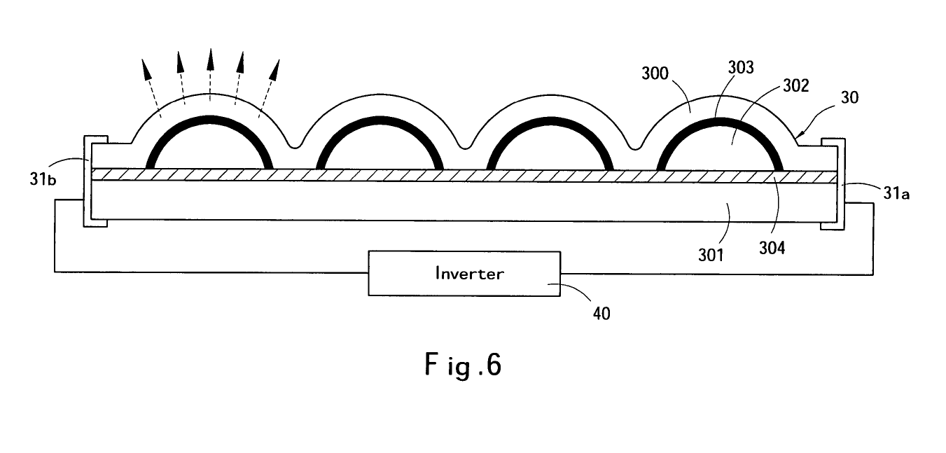

Please refer to FIGS. 4 to 6 respectively for the perspective view, exploded view and cross-sectional view of the present invention being connected to a power supply. In the figures, the invention comprises a gas discharge lamp 30 (which further comprises an upper glass substrate 300 and a lower glass substrate 301, and a close cavity 302 being defined between the upper glass substrate 300 and the lower glass substrate 301 and filled with a reactant gas; wherein the cavity 302 is coated with a fluorescent material 303 on a surface proximate to the upper glass substrate 300, and the lower glass substrate 301 is coated with a reflective material 304 on the surface proximate to the cavity 302) and two conductors 31a, 3b (including an anode and a cathode, and both are made by nickel in this preferred embodiment) for covering on any two corresponding end surfaces of the foregoing gas discharge lamp 30 to activate the power supply 40 to light up the gas discharge lamp 30 and provide a power transmission effect for the gas discharge lamp 30, wherein the power supply 40 is a backlight inverter implemented by a piezoelectric transformer or a transformer. If the piezoelectric transformer is used, its high-voltage electric output can activate the large-size gas discharge lamp to emit light). Further, the surface of the conductors 31a, 31b is coated by an ultraviolet (UV) resisting material or a polarized material.

In view of the description above, the electric connection assembly of the flat panel gas discharge lamp 30 in accordance with the invention comprises two conductors 31a, 31b covering any two corresponding end surfaces of the gas discharge lamp 30 to substitute the complicate layout for making the electrodes and use a power supply 40 to transmit electric power to the gas discharge lamp 30 through the conductors 31a, 31b to light up the gas discharge lamp 30. Therefore, the present invention installs simple components to achieve the electric connection effect, not only simplifying the manufacturing process, but also having the time-saving and cost-saving advantages. Therefore, the present invention is a major contribution to the industry.

Further, the operation of the power supply 40 according to the present invention is described below.

Please refer to FIGS. 4 to 6 again. In the figures, the present invention uses a power supply 40 (a backlight inverter) to represent the connection status of the electric connection assembly of a flat panel gas discharge lamp 30, and the power supply 40 provides electric power to the gas discharge lamp 30 through the two conductors 31a, 31b, so that the reactant gas in the cavity 302 of the gas discharge lamp 30 produces a discharge phenomenon and discharge ultraviolet rays to activate the fluorescent material coated on the surface of the upper glass substrate 300 to emit light as to define the electric connection assembly of the flat panel gas discharge lamp 30 in accordance with the invention.

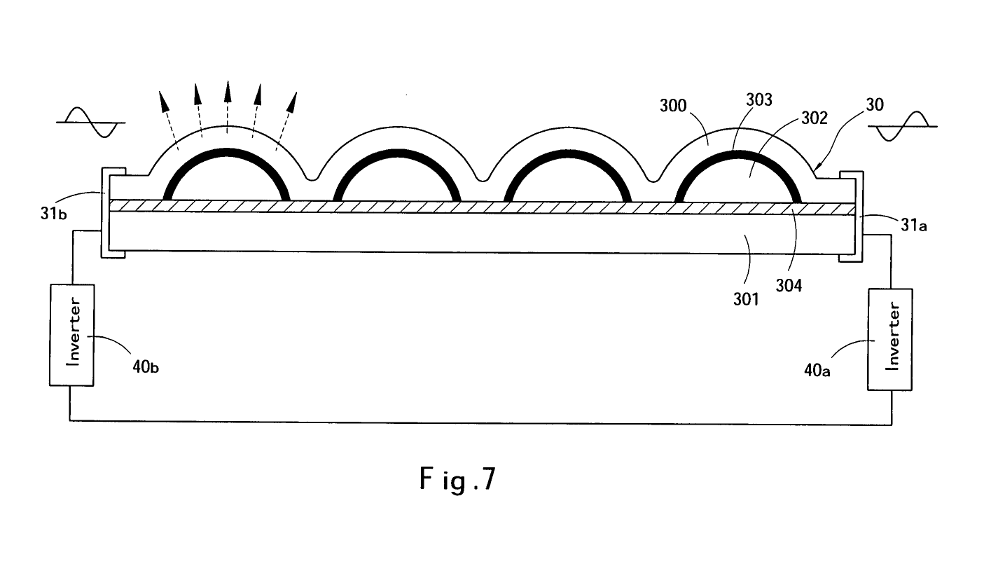

Please refer to FIG. 7 for another preferred embodiment of the present invention, which adopts a push-pull method to connect two power supplies 40a, 40b (the preferred embodiment adopts a piezoelectric transformer) and provide a larger power to the gas discharge lamp 30 by the addition of the positive and negative half-cycle electric power (for example, if the positive half cycle of the output voltage is 2000v and the negative half cycle is 2000v, then an electric power of up to 4000v will be provided) as to drive the reactant gas in the cavity 302 of the gas discharge lamp 30 to produce a discharge phenomenon and activate the fluorescent material coated on the surface of the upper glass substrate 300 to emit light. Therefore, the invention further fits the large-size gas discharge lamp 30 to achieve the purpose of emitting light evenly.

While the invention has been described by means of specific embodiments, numerous modifications and variations could be made thereto by those skilled in the art without departing from the scope and spirit of the invention set forth in the claims.

What is claimed is:

1. An electric connection assembly of flat panel gas discharge lamp, for providing a simple electric connection assembly to a power supply of a gas discharge lamp, characterized in that said electric connection assembly comprises an electric conductor being covered individually onto two corresponding end surfaces of said gas discharge lamp and provides an electric power transmission effect for said power supply and said gas discharge lamp.

2. The electric connection assembly of flat panel gas discharge lamp of claim 1, wherein said electric conductor is comprised of an anode and a cathode.

3. The electric connection assembly of flat panel gas discharge lamp of claim 1, wherein said electric conductor is made of nickel.

4. The electric connection assembly of flat panel gas discharge lamp of claim 1, wherein said power supply is a backlight inverter.

5. The electric connection assembly of flat panel gas discharge lamp of claim 4, wherein said backlight inverter is a piezoelectric transformer.

6. The electric connection assembly of flat panel gas discharge lamp of claim 4, wherein said backlight inverter is a transformer.

7. The electric connection assembly of flat panel gas discharge lamp of claim 1, wherein said gas discharge lamp comprises an upper glass substrate and a lower glass substrate, and a close cavity defined between said upper glass substrate and said lower glass substrate and filled with a reactant gas.

8. The electric connection assembly of flat panel gas discharge lamp of claim 7, wherein said cavity is coated with a fluorescent material proximate to the surface of said upper glass substrate.

9. The electric connection assembly of flat panel gas discharge lamp of claim 7, wherein said lower glass substrate is coated with a reflective material proximate to the surface of said cavity.

10. The electric connection assembly of flat panel gas discharge lamp of claim 1, wherein said gas discharge lamp is coupled to two power supplies by a push-pull method.

11. The electric connection assembly of flat panel gas discharge lamp of claim 10, wherein said power supply is a piezoelectric transformer.

12. The electric connection assembly of flat panel gas discharge lamp of claim 1, wherein said conductor is coated by a material selected from the collection of an UV material, an antistatic charge material, and a polarized material.
